(19) United States
(12) Patent Application Publication
(10) Pub. No.: US 2010/0050260 A1
(43) Pub. Date: Feb. 25, 2010

(54) Attack node set determination apparatus and method, information processing device, attack dealing method, and program

(75) Inventors: Hirofumi Nakakoji, Yokohama (JP); Tetsuro Kito, Yokohama (JP); Masato Terada, Kawasaki (JP); Shinichi Tankyo, Yokohama (JP); Isao Kaine, Kawagoe (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi Information Systems, Ltd.

(21) Appl. No.: 12/461,363

(22) Filed: Aug. 10, 2009

(30) Foreign Application Priority Data
Aug. 25, 2008 (JP) 2008-215989

(51) Int. Cl. G06F 11/00

(52) U.S. Cl. 726/23

(57) ABSTRACT

An attack node set determination apparatus obtains an event log basic parameter extracted from collected event logs and attribute information based on the event log basic parameter. The attack node set determination apparatus performs a clustering on a space having dimensions of part or all of the obtained attribute information and event log basic parameter, computes a cluster, and transmits information on the cluster and a countermeasure against the cluster to a firewall. Upon detecting an attack packet from an attack node set, the firewall identifies a cluster including the attack packet and conducts a countermeasure against the whole identified cluster.

### INCORPORATION BY REFERENCE

This application claims priority based on a Japanese Patent Application No. 2008-215989 filed on Aug. 25, 2008, the disclosure of which is incorporated herein by reference.

### BACKGROUND

The present invention relates to a technique of determining a node set which conducts an unauthorized activity, and controlling an access from the node set.

A number of computers are coupled to the Internet. The computers are subject to unauthorized accesses. For example, a person who does not have an authorized access right to a computer exploits a security hole of software in the computer, or creates a downloadable program infected by a computer virus to intentionally produce a backdoor so as to make the computer freely available without authentication. Further, there have been rapidly increasing DDoS (Distributed Denial of Service attack) attacks or cyber attacks in a distributed manner from multiple points, using a botnet which is a network constituted by computers controlled by those who do not have authorized access rights.

To cope with such problems, there have been known the Intrusion Detection System (hereinafter referred to as IDS) for detecting unauthorized accesses, a firewall for maintaining security of a specific computer network from unauthorized accesses, or the like. The IDS utilizes a previously-registered information pattern of a packet used for an unauthorized access, monitors a packet having the information pattern, and detects an unauthorized access. The firewall detects whether a packet is authorized or unauthorized, based on previously-set information in which whether or not an access is permitted is determined by the IP address or the port number.

Japanese Laid-Open Patent Application, Publication No. 2005-197823 (to be referred to as Reference 1 hereinafter) discloses a technique of blocking an unauthorized access, in which, if a firewall detects an unauthorized access, the firewall identifies an IP address of a source of the unauthorized access, sets a drop of the IP address using a filtering function of a router installed in a LAN, and drops a packet related to the IP address of the unauthorized access source (see paragraph 0019).

### SUMMARY

However, the DDoS attacks or cyber attacks have been more and more sophisticated and complicated. An attack node launching an attack quickly comes and goes and is soon followed by others.

Therefore, as disclosed in Reference 1, it is inefficient to individually deal with each IP address of a large number of unauthorized access sources. Such an individualized countermeasure has the problem of not capable of detecting a newly-launched attack having a characteristic not the same as but similar to an attack launched before. This is because the countermeasure only detects an attack having an IP address identical to that previously registered, thus leading to a belated countermeasure.

The disclosed system provides a technique of grouping a plurality of attack nodes each having a similar characteristic into an attack node set and conducting a countermeasure against the attack node set.

An attack node set determination apparatus: collects event logs; extracts basic item information from the collected event logs; creates attribute information by processing the basic item information or checking a targeted node based on a basic item; performs a clustering on the attribute information; computes events each having a similar characteristic; and sets clusters as a result of the computation in an information processing device. After the setting, if an unauthorized access is detected, the information processing device identifies a cluster including an event related to the unauthorized access and conducts a previously-set countermeasure against the unauthorized access on the whole identified cluster.

A plurality of attack nodes having similar characteristics are made into clusters. A countermeasure is taken on a whole target cluster. This can improve efficiency of countermeasure operations and prevent a newly-attempted attack from an attack node having a similar characteristic to that previously attacked.

According to the teaching herein, it becomes possible to determine a node set which conducts an unauthorized activity and control an access from the node set.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a diagram illustrating a configuration example of an attack node set determination system according to an embodiment of the present invention.

FIG. 2A, FIG. 2B, and FIG. 2C are examples of event logs of an IDS, a firewall (rooter), and a Web, respectively, according to the embodiment.

FIG. 3 is an example of a configuration of an attack node set determination apparatus according to the embodiment.

FIG. 4 is an example of an event database according to the embodiment.

FIG. 5 is an example of a distance function assignment policy stored in a policy database according to the embodiment.

FIG. 6 is an example of an action policy stored in the policy database according to the embodiment.

FIG. 7 is an example of a distance function definition stored in a distance function database according to the embodiment.

FIG. 8 is an example of port ranging matrix and a protocol ranging matrix stored in the distance function database according to the embodiment.

FIG. 9 is an example of a line type ranging matrix and a service ranging matrix stored in the distance function database according to the embodiment.

FIG. 10 is an example of an OS ranging matrix stored in the distance function database according to the embodiment.

FIG. 11 is a diagram showing a flow of a processing in an analysis program according to the embodiment.

FIG. 12 is an example of a collective behavior cluster according to the embodiment.

FIG. 13 is an example of operations of an attack node set detection system according to the embodiment.

FIG. 14A is an explanatory diagram of a processing of dealing with an unauthorized access according to a Comparative Example. FIG. 14B is an explanatory diagram of a processing of dealing with an unauthorized access according to the embodiment.

FIG. 15A is an example of source IP addresses of event logs before a clustering according to the embodiment.

FIG. 15B is an example of the relocated source IP addresses of event logs and clusters after the clustering according to the embodiment.

### DETAILED DESCRIPTION OF THE EMBODIMENTS

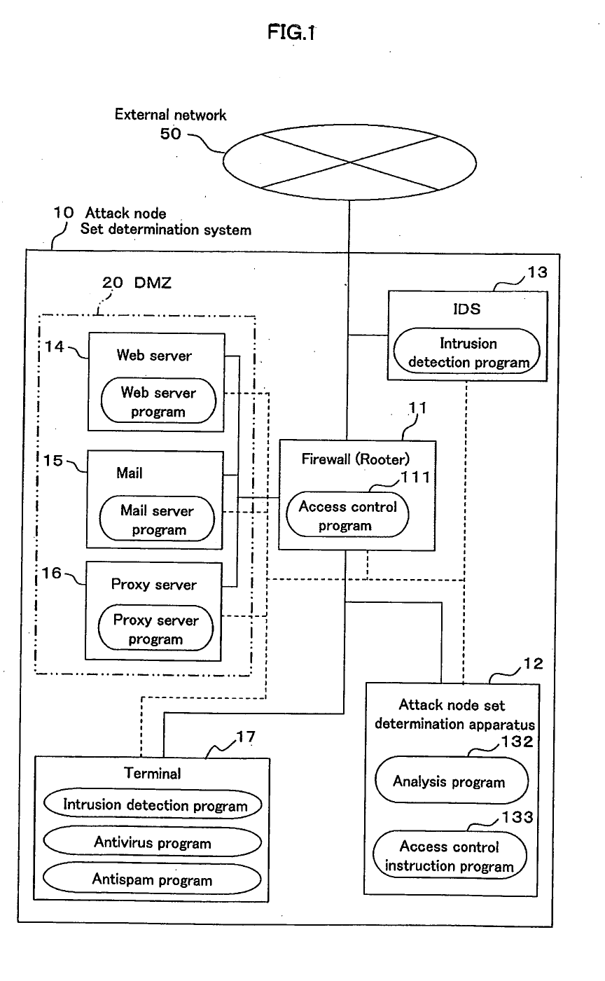

Next is described a configuration example of an attack node set detection system in which a characteristic of an unauthorized access is extracted, and a plurality of attack nodes each having a characteristic similar to the extracted characteristic of the unauthorized access are grouped, with reference to FIG. 1.

In FIG. 1, an attack node set determination system 10 includes a firewall (rooter) 11, an attack node set determination apparatus 12, an IDS 13, a Web server 14, a mail server 15, a proxy server 16, and a terminal 17. FIG. 1 shows only one unit of the above-mentioned components 11 to 17. However, a plurality of units thereof may be provided.

The firewall 11 (which may also be referred to as an information processing device) maintains security of the terminal 17 or the like coupled to a network (for example, an intranet) configured on an inward side of the firewall 11. This is achieved by permitting only a packet having an authorized communication to pass through, from among packets transmitted from an external network 50 coupled to an outward side of the firewall 11. For example, the firewall 11 includes a DMZ (DeMilitarized Zone) 20 and allows access from the external network 50 to the Web server 14, mail server 15, and proxy server 16 which are installed in the DMZ 20. The firewall 11 implements a prescribed processing of an unauthorized packet using an access control program 111. For example, the firewall 11 drops the unauthorized packet or reports an unauthorized access to an administrator. The firewall 11 then stores a log regarding the unauthorized access as an event log.

The IDS 13 monitors a packet flowing in the external network 50 using an intrusion detection program and detects an unauthorized packet. The IDS 13 stores therein a log concerning the detected unauthorized packet as an event log.

The Web server 14 offers a Web service using a Web server program. Upon offering the service, the Web server 14 stores therein a log concerning an access to a Web page and an authentication each as an event log.

The mail server 15 offers a service related to e-mailing using a mail server program. Upon offering the service, the mail server 15 stores a log concerning mail delivery, mail reception, authentication, detection of a virus-containing mail, or detection of a spam mail each as an event log.

The proxy server 16 performs communications, in place of the terminal 17, if the terminal 17 coupled to the network on the inward side of the firewall 11 uses a service such as the Web, FTP (File Transfer Protocol), Telnet, and the like offered by a server coupled to the external network 50. Upon the communication, the proxy server 16 stores therein a log concerning access and authentication as an event log.

The terminal 17 is embodied by, for example, a personal computer (PC). The terminal 17 monitors an unauthorized access using an intrusion detection program, an antivirus program, an antispam program, or the like and stores therein a log concerning the unauthorized access as an event log.

The attack node set determination apparatus 12 collects event logs from the firewall 11, IDS 13, Web server 14, mail server 15, proxy server 16, and terminal 17; performs a clustering of events in the collected event logs using an analysis program; and groups attack nodes having similar characteristics to each other into clusters. The attack node set determination apparatus 12 transmits information on the clustering and a countermeasure against attack nodes to the firewall 11, based on results of the clustering and using an access control instruction program. Details of such a processing performed by the attack node set determination apparatus 12 will be described later.

It is to be noted that, in FIG. 1, a solid line or a two-dot chain line connecting blocks 14 to 17 does not represent wiring. The solid line instead represents a transmission path of a communication packet other than an event log. The two-dot chain line represents a path of collecting an event log.

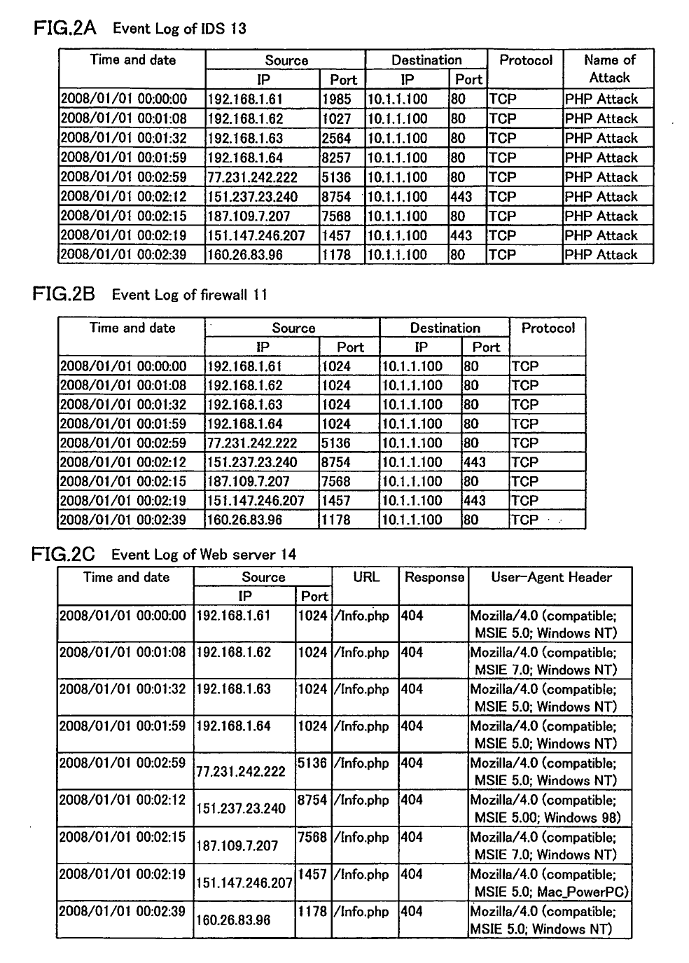

FIG. 2A, FIG. 2B, and FIG. 2C are examples of event logs of an IDS, a firewall (rooter), and a Web, respectively.

In FIG. 2A, the IDS 13 records a time and date of an event, an IP address and a port of a source, an IP address and a port of a destination, a protocol, and a name of an attack.

In FIG. 2B, the firewall 11 records a time and date of an event, an IP address and a port of a source, an IP address and a port of a destination, and a protocol.

In FIG. 2C, the Web server 14 records a time and date of an event, an IP address and a port of a source, a URL (Uniform Resource Locator), a response, and a User-Agent header. The User-Agent header indicates information on a user-agent which generates a request.

A configuration of each of the firewall 11, IDS 13, Web server 14, mail server 15, proxy server 16, and terminal 17 is not specifically shown herein. However, each of those components includes a computing unit for performing various computation processings using an application program and generating an event log, an input unit for inputting information, a display unit for screen-displaying a computation result and an instruction, a communication unit for controlling communications with other units, and a storage unit for storing the application program and computation result. Details of a configuration of the attack node set determination apparatus 12 will be described later.

### Outline of this Embodiment

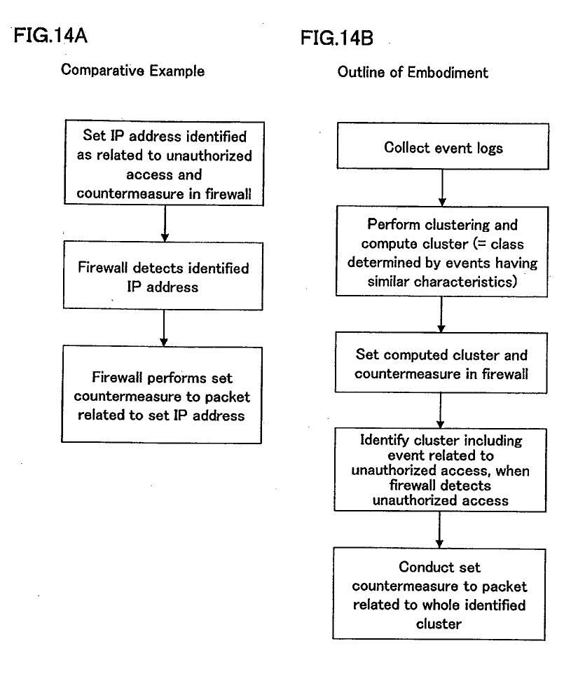

Next is described an outline of this embodiment with reference to FIG. 14A and FIG. 14B.

FIG. 14A is an explanatory diagram of a processing of dealing with an unauthorized access according to a Comparative Example. FIG. 14B is an explanatory diagram of a processing of dealing with an unauthorized access according to this embodiment.

The Comparative Example of FIG. 14A deals with IP addresses of individual unauthorized access sources.

First, an IP address identified as related to an unauthorized access and a countermeasure to deal with the IP address are set for each IP address in the firewall 11 (see FIG. 1). After the setting, if the firewall 11 detects the identified IP address, the firewall 11 performs the set countermeasure against a packet having the identified IP address.

That is, the Comparative Example sets an IP address of a packet related to an unauthorized access and a countermeasure against the packet for each IP address in the firewall 11 and performs the set countermeasure by the firewall 11 for each set IP address.

Next is described the outline of this embodiment shown in FIG. 14B (see also FIG. 1 where necessary).

First, the attack node set determination apparatus 12 collects event logs from the firewall 11, IDS 13, Web server 14, mail server 15, proxy server 16, and terminal 17. The attack node set determination apparatus 12 then performs a clustering of the collected event logs and computes a cluster. The cluster is a class dependent on events having similar characteristics to each other so as to deal with a botnet. The similar characteristics herein mean, in a case of DDoS attack or a cyber attack which may be attempted if a person living in a country makes a protest against another country, for example, a specific country or a specific IP address. The attack node set determination apparatus 12 sets the computed cluster in the firewall 11.

After the setting, if the IDS 13 or firewall 11 detects an unauthorized access, the firewall 11 identifies a cluster including an event related to the unauthorized access. The firewall 11 then performs a previously-set countermeasure against a packet related to the whole identified cluster.

That is, in this embodiment, a cluster and a countermeasure thereagainst are set in advance in the firewall 11, and the firewall 11 performs the set countermeasure against a whole cluster related to an unauthorized access.

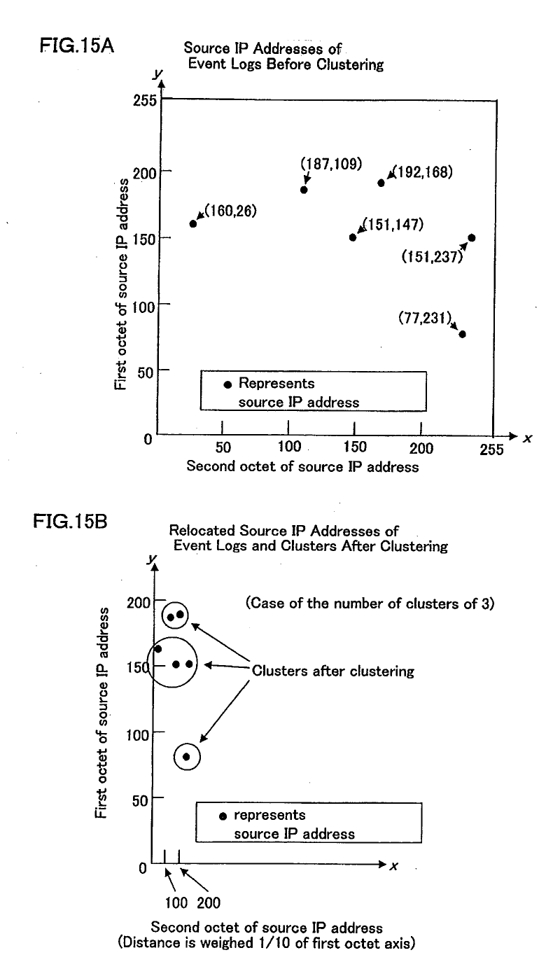

Next is described creation of a cluster taking a source IP address included in an event log as an example, with reference to FIG. 15A and FIG. 15B. FIG. 15A shows an example of source IP addresses of event logs before a clustering. FIG. 15B shows an example of the relocated source IP addresses of event logs and clusters after the clustering. To simplify description, FIG. 15A and FIG. 15B are each two-dimensional with a first octet on the y-axis and a second octet on the x-axis.

Note that, in FIG. 15A, six source IP addresses are plotted, and numeric characters in parenthesis represent (x, y).

FIG. 15B shows an example in which a clustering is performed with the number of clusters of 3 (three) using k-means as a clustering technique.

In k-means, six plots are arbitrarily assigned to three clusters as initial values. Centroids of the clusters are computed. Plots having the shortest distances to the same centroid are grouped into the same cluster. Then, the centroids of respective clusters are re-computed, and distances between the re-computed centroids and plots are further computed to determine which plots are the closest. Such computations are repeated until the clusters and ranges (sizes) thereof reach convergence.

FIG. 15B shows an example in which a distance on the x-axis is weighed to be one tenth of a distance on the y-axis. A range of each cluster is shown as a circle. <<Attack Node Set Determination Apparatus>>

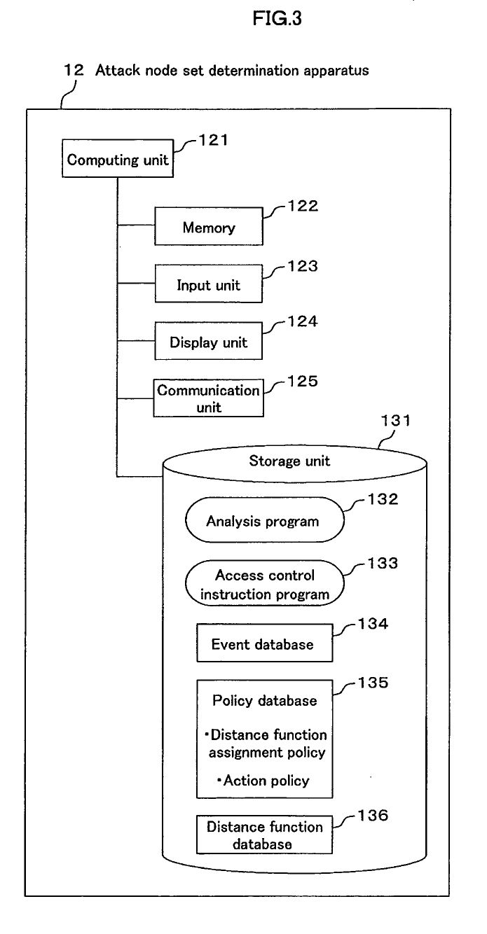

Next is described a configuration of the attack node set determination apparatus 12 with reference to FIG. 3.

The attack node set determination apparatus 12 includes a computing unit 121, a memory 122, an input unit 123, a display unit 124, a communication unit 125, and a storage unit 131.

The computing unit 121 provides control on respective units 122 to 125, 131 of the attack node set determination apparatus 12 and manages information transmission among the units 122 to 125, 131. The computing unit 121 is, for example, a CPU (Central Processing Unit) for performing computation processings. The CPU develops an application program in the memory 122 as a main storage and executes the application program, to thereby realize various computation processings. The memory 122 is embodied by a RAM (Random Access Memory). Note that the application program is stored in the storage unit 131.

The input unit 123 is, for example, a keyboard or a mouse. The input unit 123 receives an input of information by an administrator who operates the attack node set determination apparatus 12, or the like.

The display unit 124 is, for example, a CRT (Cathode Ray Tube) or a LCD (Liquid Crystal Display). The display unit 124 displays a screen for prompting a user to input information, or a screen for confirming results of computation.

The communication unit 125 transmits and receives information to and from respective units 11, 13 to 17 (see FIG. 1) of the attack node set determination system 10 and a computer not shown and coupled to the external network 50.

The storage unit 131 stores therein an analysis program 132, an access control instruction program 133, an event database 134, a policy database 135, and a distance function database 136. The analysis program 132 and access control instruction program 133 are developed as application programs in the memory 122 and are executed by the computing unit 121.

The analysis program 132 performs a clustering on collected event logs, using information stored in the event database 134, policy database 135, and distance function database 136 and determines a collective behavior cluster. The collective behavior cluster used herein means a cluster which has events strongly related to each other (that is, a cluster having a high evaluation value, which is described hereinafter), among all clusters. The analysis program 132 sets a countermeasure against an unauthorized access with respect to a collective behavior cluster. For example, if a collective behavior cluster includes an event related to an unauthorized access, the analysis program 132 sets a countermeasure of blocking a communication (that is, dropping a packet). If too many packets are transmitted to a specific node (for example, the Web server 14), the analysis program 132 sets a countermeasure of controlling bandwidth. Details of operations of the analysis program 132 will be described later.

The access control instruction program 133 transmits information on the collective behavior cluster determined by the analysis program 132 and a countermeasure thereto, to the firewall 11.

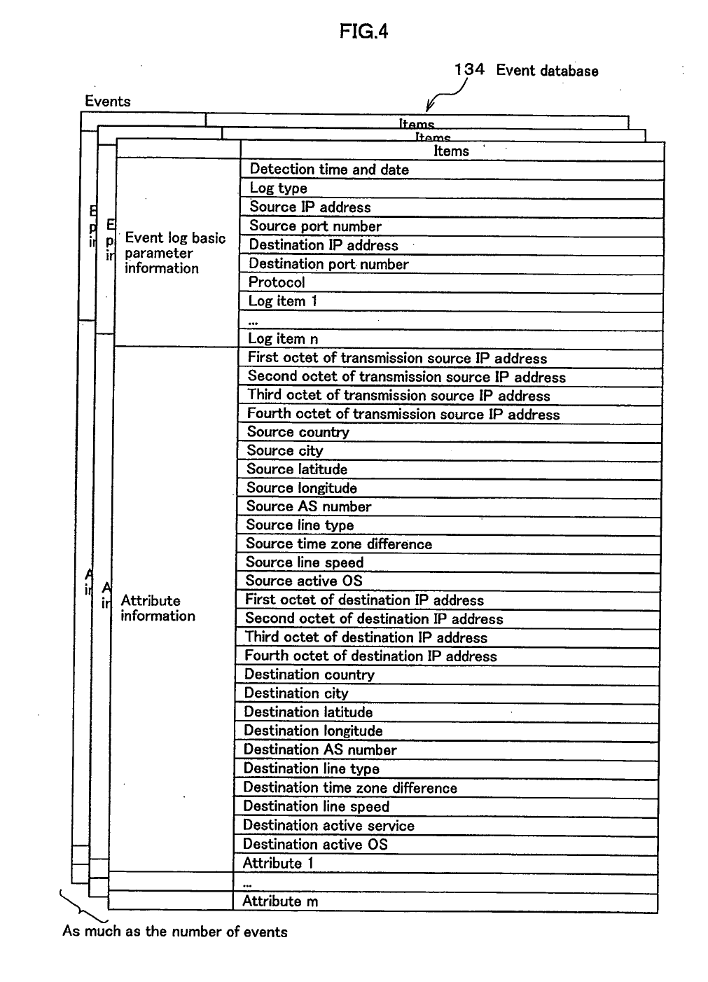

Next is described the event database 134 with reference to FIG. 4. FIG. 4 shows an example of the event database 134.

The event database 134 includes, for each event, event log basic parameter information (basic item information) and attribute information. The event log basic parameter information is information on an item extractable from an event log. The attribute information is information on items obtained by processing an item in the event log basic parameter information or checking a node related to an IP address included in the event log basic parameter information.

The event log basic parameter information includes items as follows.

A detection time and date is a time and date when an event is detected.

A log type is information for identifying a unit which transmits an event log.

A source IP address is an IP address set in a node responsible for an event having been subjected to recording. For example, if such an event occurs in the firewall 11, the source IP address is an IP address of an access source to the firewall 11. If in the IDS 13, an IP address of an attack source. If in the Web server 14, a client. If in the mail server 15, a transmitter of SMTP (Simple Mail Transfer Protocol) or POP (Post Office Protocol). And, if in the proxy server 16, a proxy user. Note that, if an event occurs in the terminal 17, the source IP address is defined according to a software installed on the terminal 17.

A source port number is a port number of a node responsible for an event having been subjected to recording. The source port number is defined according to the log type, like the source IP address.

A destination IP address is an IP address of a destination related to an event of delivering a packet. For example, if such an event occurs in the firewall 11, the destination IP address is an IP address of an access destination to the firewall 11. If in the IDS 13, an IP address of an attack destination. If in the Web server 14, an IP address of the Web server 14 itself. If in the mail server 15, an IP address of a mail destination. And, if in the proxy server 16, an IP address of a proxy access destination. Note that, if an event occurs in the terminal 17, the destination IP address is defined according to a software installed on the terminal 17.

A protocol is a protocol used in a communication related to an event. For example, the protocol may be TCP (Transmission Control Protocol), UDP (User Datagram Protocol), ICMP (Internet Control Message Protocol), or the like.

Note that the items of the event log basic parameter are not limited to those as described above. The items may also include, for example, a virus name in an antivirus software, according to a configuration of a unit from which an event log is transmitted.

The attribute information includes items as follows. An n-th octet of a source IP address is, in IPv4, n=1 to 4, and, in IPv6, n=1 to 16. Note that IP addresses may be broken down by the octet.

A source country, a source city, a source latitude, a source longitude, a source AS (Autonomous System) number, a source line type, and a source time zone difference are derived from a source IP address as an event log basic parameter of: a location country, a location city, a location latitude, and a location longitude of a node with the IP address assigned thereto; an AS (Autonomous System) number and a line class to which the located node belongs; and a time difference in the located zone, respectively. Those items are obtained by referencing IP addresses stored in the storage unit 131 in advance and a table having the items associated with the IP address or by using an outside service providing information similar to that in the above-mentioned table.

The line type includes, for example, dial-up, ISDN (Integrated Services Digital Network), ADSL (Asymmetric Digital Subscriber Line), Cable TV, and FTTH (Fiber To The Home).

A source line speed is information on a network environment of the source IP address. The source line speed is, for example, a response time, TTL (Time To Live), or the like obtained by checking the source IP address by the analysis program 132 (see FIG. 3) using a check packet with ICMP (ping).

A source active OS is information obtained by actively checking the network environment of the source IP address by the analysis program 132 (see FIG. 3). For example, information on an OS on a node is obtained by using a check packet by means of a technique of OS stack fingerprinting. If an identifier of an OS or a client software is written in an event log, as in the case of the Web server 14, the source active OS can be determined by referencing the identifier.

Items having names starting with “destination” in the attribute information are derived from a destination IP address as an event log basic parameter, as in the case of the items having names starting with “source”. Description of the following items is thus omitted herefrom: an n-th octet of a destination IP address, a destination country, a destination city, a destination latitude, a destination longitude, a destination AS (Autonomous System) number, a destination line type, a destination time zone difference, a destination line speed, and a destination active OS.

A destination active service is a service name determined by a destination port number or a service name written in an item constituting an event log. For example, if the destination port number is 80, the destination active service is Web. If the destination active service is an event obtained when the IDS 13 detects a packet attacking SQLServer (registered trademark), the service name is SQLServer (registered trademark).

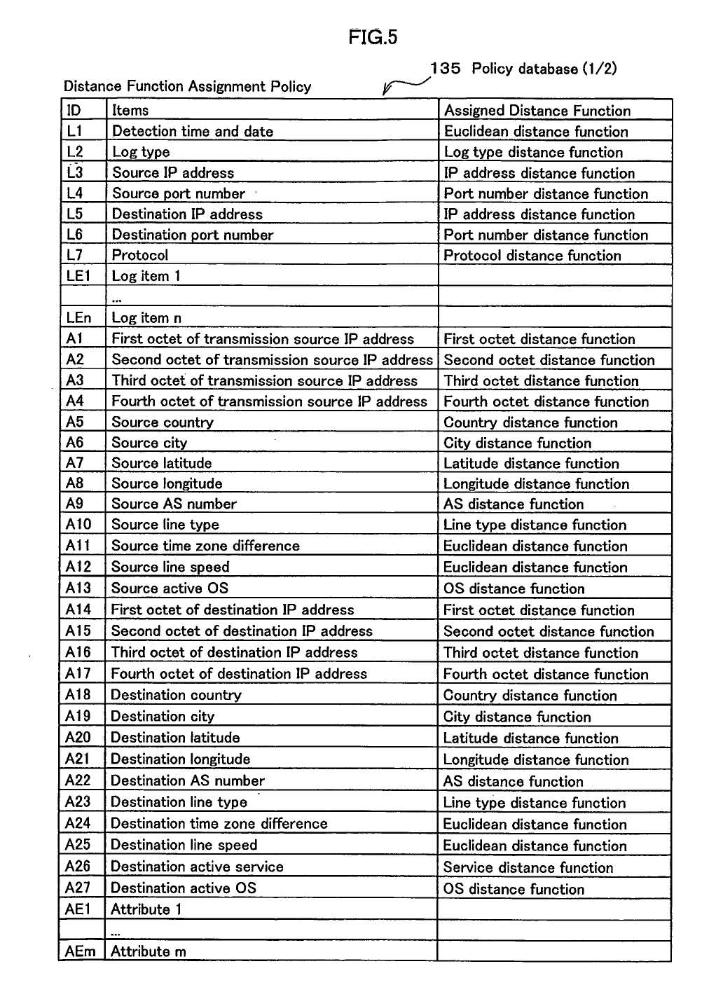

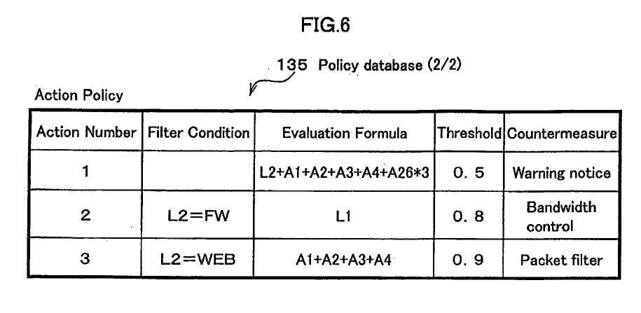

Next is described the policy database 135 shown in FIG. 3, with reference to FIG. 5 and FIG. 6. FIG. 5 shows an example of a distance function assignment policy stored in a policy database. FIG. 6 shows an example of an action policy stored in the policy database.

As shown in FIG. 5, the distance function assignment policy includes the item of events in the event database 134, distance functions for the respective items, and IDs for identifying the items. For example, an Euclidean distance function and an identifier L1 are assigned to a detection time and date. A first octet distance function and an identifier A1 are assigned to a first octet of a source IP address. Description of the other items is omitted herefrom.

Next is explained a distance function. Generally, if a cluster is obtained using a clustering technique, a distance function between data is defined.

In a two-dimensional Euclidean space, a distance between data A (xa, ya) and data B (xb, yb) is usually calculated as follows. A distance between data A and data B on the x-axis is an absolute value of a difference between “xa” and “xb”. A distance between data A and data B on the y-axis is an absolute value of a difference between “ya” and “yb”. The distance between data A and data B is obtained by calculating a square root of square sum of the two absolute values. The x-axis and the y-axis herein are equally scaled.

In this embodiment, the item of each event is assumed to be an axis. A distance between two points is calculated differently according to a characteristic of an axis used. In other words, the axes used are differently weighed.

For example, as shown in FIG. 15B, a distance on the x-axis is weighed to be one tenth of a distance on the y-axis.

Next is explained an action policy of the policy database 135 shown in FIG. 6.

The action policy includes an action number, a filter condition, an evaluation formula, a threshold, and a countermeasure.

The action number is a number for identification.

The filter condition is a condition used when a data of an event log is screened through a filter, which is used in performing a clustering. For example, if the action number is 3, L2 is WEB. L2 represents an ID shown in FIG. 5 and indicates a log type. “WEB” indicates that an event log on a Web server is targeted.

The evaluation formula is A1+A2+A3+A4 in a case in which the action number is 3, wherein A1, A2, A3, and A4 indicate the IDs shown in FIG. 5. The evaluation formula is defined as a formula in which: A1, A2, A3, and A4 are assumed to be axes; squares of distances obtained by projecting two points on respective axes are added up; and a fourth root of the added results is calculated. In the evaluation formula, in a case in which the action number is 1, L2, A1, A2, A3, A4, and A26×3 (weighting of A26 is 3) are assumed as axes; squares of distances obtained by projecting two points on respective axes are added up; and a sixth root of the added results is calculated.

For a cluster obtained by a clustering, an evaluation value is obtained which is a quantified combination of a ratio of the number included in the cluster with respect to the total number of events, the number of events, a variance value, and an average of a distance between a centroid of the cluster and an event included in the cluster (which may also be referred to as an evaluation value of the cluster). In this embodiment, the larger the evaluation value is, the higher a correlation between events becomes.

The filter condition and the evaluation formula may also be referred to as filter information.

The threshold is used in determining whether an evaluation value of a cluster is larger or smaller than the threshold. If the evaluation value of the cluster is larger than the threshold, the cluster is determined to have events highly related to each other (having similar characteristics), that is, a collective behavior cluster.

The countermeasure represents contents of a processing performed against a collective behavior cluster, for example, a “warning notice” for informing an administrator of warning information, a “bandwidth control” for limiting bandwidth use on transmission, a “packet filter” for blocking a transmission, or the like.

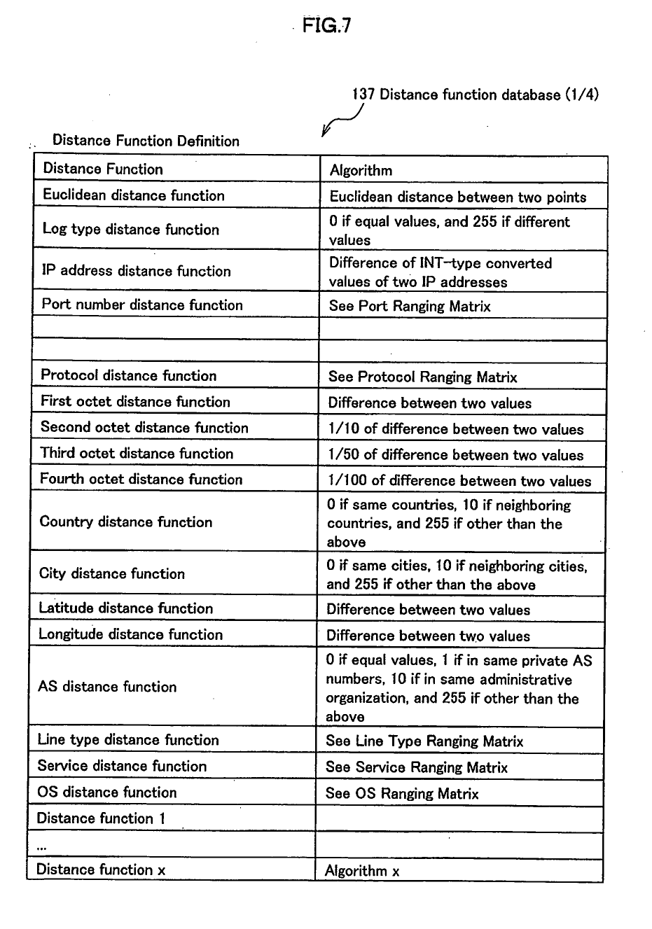

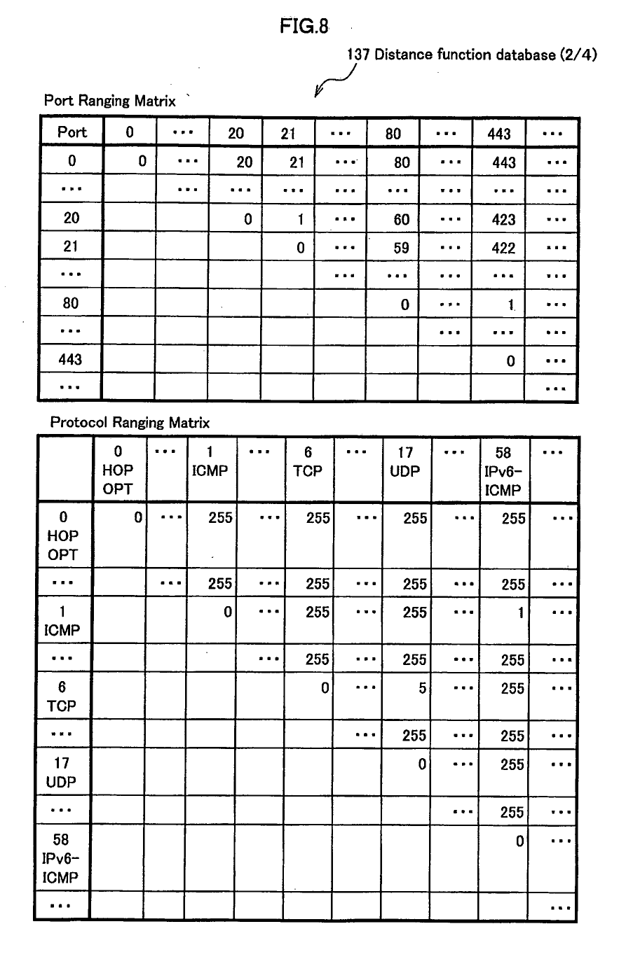

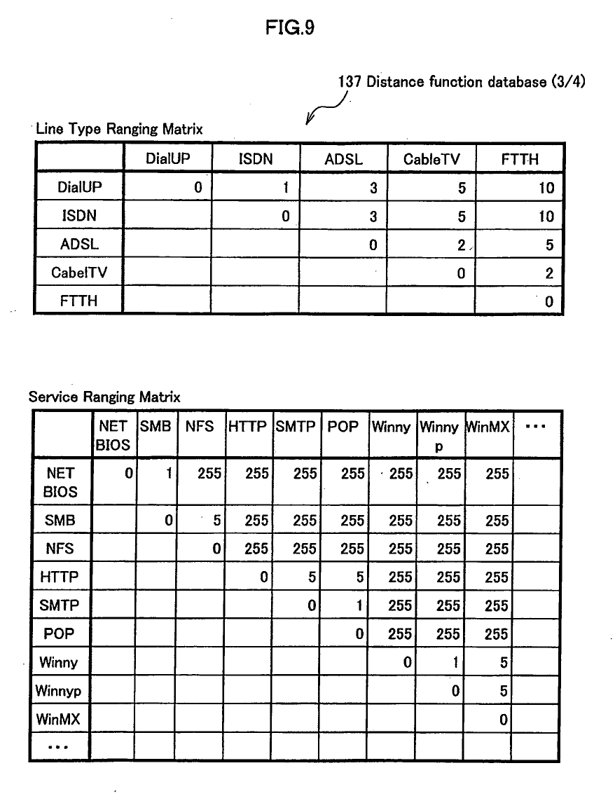

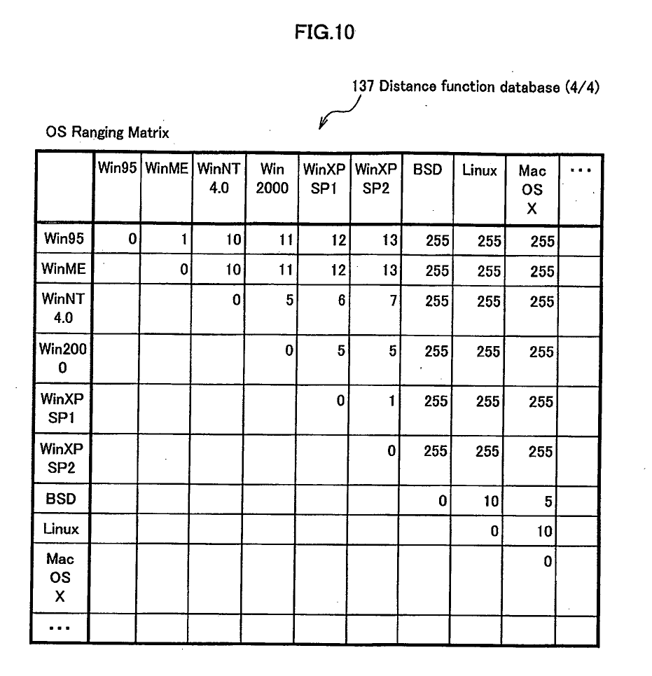

Next is described the distance function database 136 shown in FIG. 3 with reference to FIG. 7 to 10. FIG. 7 shows an example of a distance function definition stored in the distance function database 136. FIG. 8 shows an example of a port ranging matrix and a protocol ranging matrix each stored in the distance function database 136. FIG. 9 shows an example of a line type ranging matrix and a service ranging matrix each stored in the distance function database 136. FIG. 10 shows an example of an OS ranging matrix stored in the distance function database 136.

The distance function definition stores therein a distance function and an algorithm for defining the distance function. For example, an Euclidean distance function returns an Euclidean distance between two points as a return value of the distance function. A country distance function assigned to a source country (ID=A5) and a destination country (ID=18) shown in the distance function assignment policy (see FIG. 5) of the policy database 135 returns 0 (zero) as a return value of the distance function, if ranged two countries (values) are equal. If ranged two countries are neighbors, the country distance function returns 10. If ranged two countries are not equal nor neighbors, the country distance function returns 255.

The port number distance function is assigned to a destination port number (ID=L6) (see FIG. 5). The port number distance function ranges using the port ranging matrix shown in FIG. 8 and returns a return value of the distance function. For example, Port 80 which is a standard port for HTTP is similar to Port 443 which is a standard port for HTTPS in that both are used for the same Web service, though there is a difference of 363 (443−80=363) therebetween. Therefore, a distance between Port 80 and Port 443 is defined as 1 (one).

The protocol ranging matrix is used for defining a protocol distance function of the protocol distance function definition of the distance function database 137. For example, it is usually assumed that a relation between different protocols is low, and thus, a value as large as 255 is returned, if the numbers of protocols are different. However, since ICMP(1) for IPv4 and IPv6-ICMP(58) for IPv6 are both protocols concerning ICMP, a distance therebetween is defined as small as 1 (one).

The line type ranging matrix shown in FIG. 9 is used for defining a line type distance function of the distance function definition of the distance function database 137. For example, the line type ranging matrix defines a distance by grouping into a so-called narrow band line (dialup and ISDN (Integrated Services Digital Network)), a broadband line (ADSL (Asymmetric Digital Subscriber Line), Cable TV, and FTTH (Fiber To The Home)).

A service ranging matrix is used for defining a service distance function of the distance function definition of the distance function database 137. For example, since both a mail delivery service (SMTP) and a mail reception service (POP) are services concerning e-mails, the service ranging matrix defines a distance therebetween as 1 (one). Further, since applications providing services, such as Winny, Winnyp, and WinMX are all P2P file sharing software, the service ranging matrix defines a distance therebetween to be short.

An OS ranging matrix shown in FIG. 10 is used for defining an OS distance function of the distance function definition of the distance function database 137. For example, the OS ranging matrix defines a distance by grouping into: OSs having Windows (registered trademark) 9x-based kernel such as Windows (registered trademark) 95 and Windows (registered trademark) Me; OSs having Windows (registered trademark) NT-based kernel such as Windows (registered trademark) NT4.0, Windows (registered trademark) 2000, and Windows (registered trademark) XP; OSs having UNIX (registered trademark)-based kernel such as BSD, Linux (registered trademark), and Mac (registered trademark) OSX.

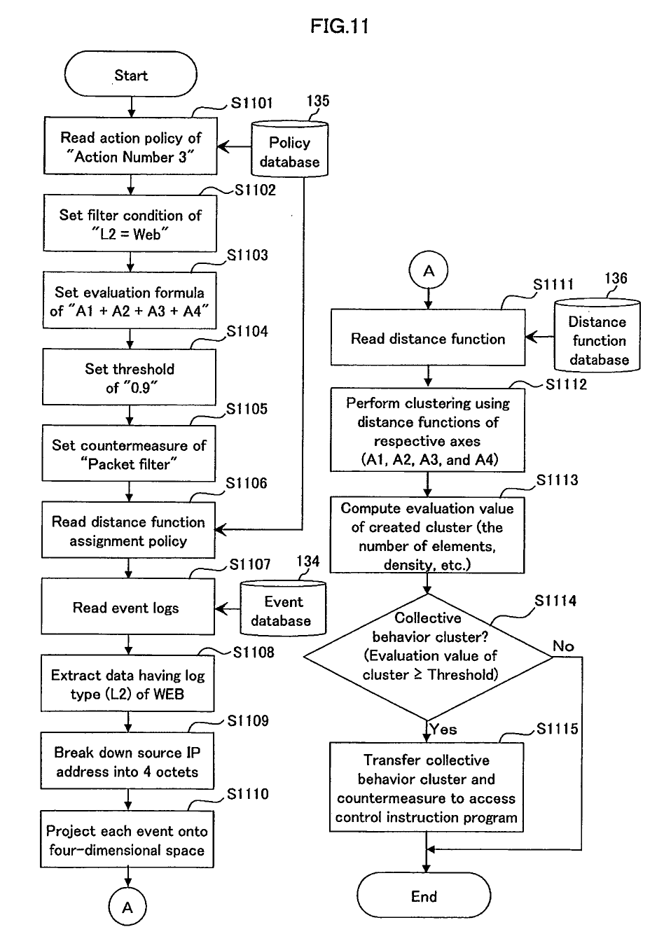

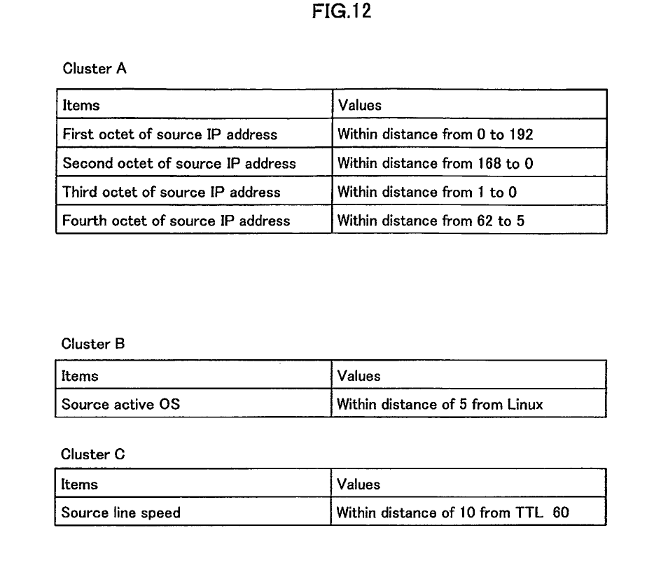

Referring back to FIG. 3, in the attack node set determination apparatus 12, the analysis program 132 carries out a clustering using the event database 134, policy database 135, and distance function database 136 and computes a collective behavior cluster. Next is described a flow of a processing in the analysis program 132 and an example of a collective behavior cluster with reference to FIG. 11 and FIG. 12, respectively.

As shown in FIG. 11, upon a startup of the analysis program 132 (see FIG. 3), the action policy (see FIG. 6) is read from the policy database 135 (step S1101). It is assumed herein that Action Number 3 is read.

Then, “L2=WEB”, “A1÷A2+A3+A4”, “0.9”, and “packet filter” are set as the filter condition, evaluation formula, threshold, and countermeasure, respectively (steps S1102 to S1105).

The distance function assignment policy (see FIG. 5) is read (step S1106). That is, distance functions corresponding to A1, A2, A3, and A4 are read.

Event logs are read from the event database 134 (see FIG. 4) (step S1107). A timing of the read may be at prescribed intervals, by every prescribed number of the event logs, for example, 1000, or by an operation of an administrator.

Out of the read event logs, data having L2=WEB is extracted based on the filter condition (step S1108).

The source IP address is broken down into 4 octets as attribute information, based on the evaluation formula (step S1109).

Each event is projected onto a four-dimensional space having A1, A2, A3, and A4 as axes (step S1110).

Respective distance functions corresponding to A1, A2, A3, and A4 are read from the distance function database 136 (see FIG. 7) (step S1111).

A clustering is performed using the respective distance functions of the axes A1, A2, A3, and A4 (step S1112).

An evaluation value of the created cluster is computed (step S1113).

It is determined whether or not the cluster is a collective behavior cluster, that is, the computed evaluation value of the cluster is compared to the threshold (step S1114).

If the evaluation value of the cluster is equal to or more than the threshold, (if Yes in step S1114), the cluster determined as a collective behavior cluster and a countermeasure thereagainst are transferred to the access control instruction program 133 (step S1115).

If the evaluation value of the cluster is not more than the threshold (If No in step S1114), the processing is terminated.

Though not shown, steps S1114 to S1115 are performed for each cluster.

In FIG. 11, the countermeasure is set in step S1105. However, the countermeasure may be set in step S1115. That is, if it is found that an event related to an unauthorized access is included in a collective behavior cluster, a countermeasure reflecting the finding may be set in step S1115.

Next is described an example of a collective behavior cluster determined by the analysis program 132.

In FIG. 12A, Cluster A is a cluster of a source IP address obtained as a result of a clustering. Cluster A is herein in a range in which all of the following conditions are satisfied: a first octet of the source IP address is within a distance from 0 to 192; a second octet thereof, from 168 to 0; a third octet thereof, from 1 to 0; and a fourth octet thereof, from 62 to 5.

In FIG. 12B, Cluster B is a cluster concerning a source active OS. Since a software type, version, or the like of the OS is designed to be identifiable, Cluster B is herein in a range in which all conditions are satisfied within a distance of 5 from Linux.

In FIG. 12C, Cluster C is a cluster concerning a source line speed. Since the line speed can be determined from a response time from a target node or TTL using ICMP (Ping), Cluster C is herein in a range in which all conditions are satisfied within a distance of 10 from TTL 60.

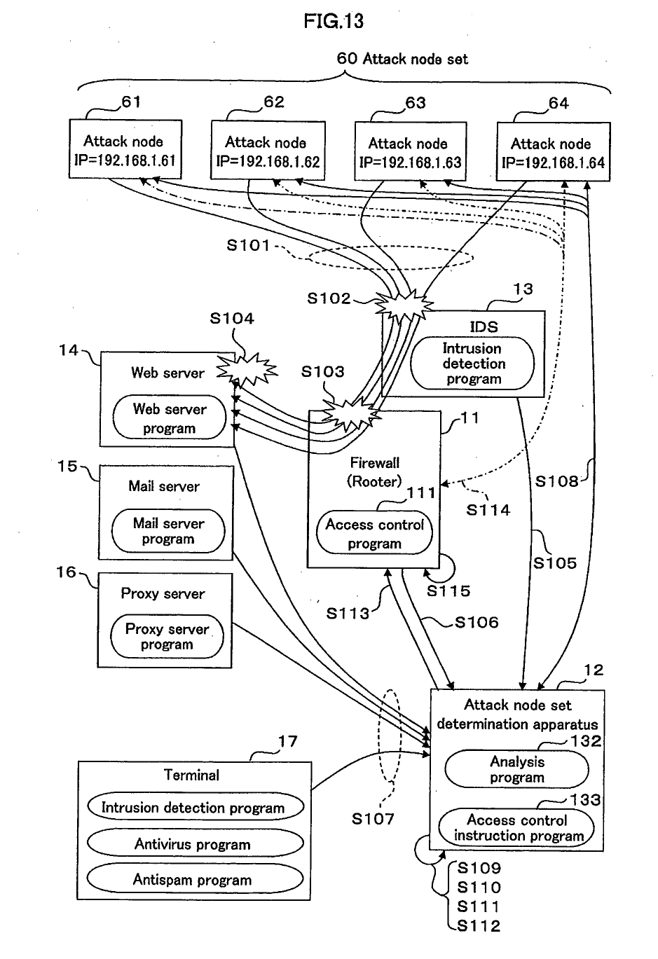

Next are described operations of the attack node set detection system according to this embodiment with reference to FIG. 13.

In FIG. 13, it is assumed that an attack is carried out against the Web server 14 from an attack node set 60 constituted by a plurality of attack nodes 61, 62, 63, 64 coupled to the external network 50 (see FIG. 1). Note that, in FIG. 13, the firewall 11, attack node set determination apparatus 12, IDS 13, Web server 14, mail server 15, proxy server 16, and terminal 17 are similar to those shown in FIG. 1, and descriptions thereof are omitted herefrom.

First, the attack node set 60 sends an attack packet to the Web server 14 (step S101).

The IDS 13 detects the attack packet sent from the attack node set 60 as an attack and records the attack as an event concerning the attack packet (step S102). The firewall 11 detects the attack packet as a passing packet and records the passing packet in an event log(step S103). The Web server 14 records the attack packet as an access record and also records the attack packet as an event log(step S104).

The attack node set determination apparatus 12 obtains respective event logs from the IDS 13, firewall 11, Web server 14, mail server 15, proxy server 16, and terminal 17 at prescribed intervals or by an operation of an administrator (steps S105, S106, and S107).

The attack node set determination apparatus 12 extracts the event log basic parameters (see FIG. 4) from the event logs; transmits a check packet to each of the attack nodes 61, 62, 63, 64 using one or more of the event log basic parameters

(for example, the source IP address); checks the attribute information (for example, the line speed and active OS); and obtains the checked attribute information (which may also be referred to as first attribute information) (see FIG. 4) (step S108). The attack node set determination apparatus 12 transmits the check packet also to a destination IP address; checks the attribute information (for example, the line speed and active OS); and obtains the checked attribute information (which may also be referred to as the first attribute information) (see FIG. 4).

The attack node set determination apparatus 12 adds the obtained attribute information to the information on the event and stores the information on the event in the event database 134. Further, the attack node set determination apparatus 12 adds the attribute information created by processing the event log basic parameters (which may also be referred to as second attribute information) to the information on the event and stores the information on the event in the event database 134 (step S109).

After adding the attribute information to the event database 134 (see FIG. 4), the attack node set determination apparatus 12 performs a clustering on the event stored in the event database 134 (step S110). The attack node set determination apparatus 12 computes an evaluation value of each cluster created by the clustering, and compares the computed evaluation value of the cluster to a threshold, to thereby conduct a cluster evaluation (step S111). The attack node set determination apparatus 12 then sets a countermeasure according to the action policy (see FIG. 6) in a cluster determined as a collective behavior cluster (step S112).

A specific example of steps S111 to S112 is described below assuming a case in which, for example, an event of an event log in the Web server 14 is subjected to a clustering, using the conditions shown in Action No. 3 of the action policy (see FIG. 6), to thereby obtain Cluster A (see FIG. 1), and an evaluation value of Cluster A including the attack node set 60 having similar source IP addresses is computed to be 0.95. Under the conditions, Cluster A has the evaluation value of 0.95 larger than the prescribed threshold of 0.9 and is thus determined as a collective behavior cluster. Then, a countermeasure against the collective behavior cluster is set according to the action policy.

The attack node set determination apparatus 12 transmits the cluster information on the collective behavior cluster including Cluster A and the countermeasure against the collective behavior cluster to the firewall 11 (step S113). The firewall 11 stores the received collective behavior cluster and the countermeasure in a storage unit thereof not shown. Upon receiving a new attack packet from the attack node set 60, the firewall 11 extracts an event log basic parameter of an event related to the packet, using the access control program 111; transmits a check packet to an attack node of interest; and obtains information on the attack node, based on the checked result (step S114). If the firewall 11 determines using the access control program 111 that Cluster A includes the packet, the firewall 11 implements the countermeasure targeting all nodes included in Cluster A (step S115).

<Variation>

In a variation, the present invention can be carried out with an existing firewall 11 which implements a countermeasure only against an IP address as a target.

That is, in a step corresponding to step S112 of FIG. 13, an IP address or a port number included in a cluster which has been determined as a collective behavior cluster represents the whole cluster. Then, the cluster is associated with a countermeasure thereagainst. In a step corresponding to step S113, an event log basic parameter related to the collective behavior cluster, attribute information created by processing the event log basic parameter (which may also be referred to as second attribute information), and a countermeasure to deal with the collective behavior cluster are transmitted to the firewall 11 and are stored in a storage unit thereof not shown. The collective behavior cluster is associated with a corresponding IP address and is stored in the storage unit.

In a step corresponding to step S114, the firewall 11 obtains attribute information on a node (which may also be referred to as first attribute information). Upon receiving a new attack packet from the attack node set 60, in a step corresponding to step S115, the firewall 11 compares an event log basic parameter of an event related to the packet and the attribute information, to the event log basic parameter and the attribute information stored in the storage unit, to thereby identify a cluster related to the attack packet. The firewall 11 references the storage unit; extracts an IP address related to the whole cluster; and implements a countermeasure against all IP addresses included in the whole cluster, based on the extracted IP address.

For example, if an IP address of a whole collective behavior cluster is represented as 192.168.1.0/24, all packets corresponding to the IP address are subjected to the same countermeasure.

As described above, the attack node set determination apparatus 20 (see FIG. 1) according to the embodiment or the variation of the present invention performs a clustering of event logs and deals with an attack by the cluster having events with common characteristics. This enables an identification of a network segment, country, region, or the like which are collectively infected by a malicious software. Further, the attack node set determination apparatus 20 deals with an attack by the cluster, which prevents a possible attack by a node which belongs to the same cluster but has not yet launched an attack. This also allows an efficient countermeasure taken not individually but by the group, unlike a stopgap countermeasure taken each time an IP address of an attack node is detected.

The embodiment and variation according to the present invention have been explained as aforementioned. However, the present invention are not limited to those explanations, and those skilled in the art ascertain the essential characteristics of the present invention and can make the various modifications and variations to the present invention to adapt it to various usages and conditions without departing from the spirit and scope of the claims.

For example, in this embodiment, as shown in FIG. 1, the IDS 13 is set up on the outward side of the firewall 11 (on a side nearer to the external network 50). However, the IDS 13 may be set up in the DMZ 20. Further, not all of the Web server 14, mail server 15, and proxy server 16 may be provided. Any one or combination of the servers 14, 15, 16 may be provided. Any unit which outputs an event log is applicable to this embodiment.

The firewall 11, attack node set determination apparatus 12, IDS 13, Web server 14, mail server 15, proxy server 16, and terminal 17 may be or may not be installed as different hardwares. Those components 11 to 17 may be installed as virtually separate units on a single hardware using a technique of software aggregation or virtualization.

A method of a clustering is not limited to k-means.

The attack node set determination apparatus 12 may operate also as the firewall 11. The Web server 14, mail server 15, proxy server 16, and terminal 17 may be designed to be capable of executing the attack node set determination apparatus 12 and access control program 111.

In the embodiment and variation, upon receiving an attack packet, the firewall 11 conducts a countermeasure to deal with the attack packet in step S115. However, the present invention is not limited to this. The firewall 11 may constantly conducts the countermeasure received in step S113, even when the firewall 11 has not yet received an attack packet. This allows the firewall 11 to conduct the countermeasure even when the firewall 11 has not yet determined whether or not a packet having a specific event is an unauthorized access.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. An attack node set determination apparatus communicably coupled to an information processing device for outputting an event log created upon a passage or a reach of a packet, comprising:
a storage unit of event information for storing therein basic item information extracted from an event log obtained from the information processing device and attribute information newly created based on the basic item information as an event;
a storage unit of policy information for storing therein a distance function each assigned to respective items of the basic item information and the attribute information, a filter for extracting a specific event from the event information, an evaluation formula for computing a degree of similarity of characteristics among events, and a threshold associated with the filter condition and the evaluation formula; and
a computing unit for referencing the policy information of the storage unit, performing a clustering on an item of the event extracted by recording the event information read from the storage unit during a prescribed period of time or by applying the filter to a prescribed number of recorded events, based on the distance function corresponding to the item, creating a cluster having events with characteristics similar to each other, computes the degree of similarity of characteristics in the cluster as the evaluation value of the cluster, and, if the evaluation value of the cluster is more than the threshold, determining the cluster as a cluster having the similar characteristics events.

2. An attack node set determination apparatus using an event log created upon a passage or a reach of a packet, comprising:
a computing unit; and
a storage unit,
wherein the storage unit stores therein filter information for extracting a specific event from among obtained event logs, a threshold associated with the filter information, and a countermeasure against a packet having the extracted specific event, and
wherein the computing unit
extracts an event to be subject to a clustering by filtering the event logs obtained during a prescribed period of time or obtained until the number thereof reaches a prescribed number, using the filter information,
extracts basic item information written in the extracted event,
obtains information on a node related to an IP address included in the basic item information, as first attribute information,
breaks down the IP address in a prescribed manner and computes the broken down IP address as second attribute information,
performs a clustering on a space having dimensions of part or all of the items in the basic item information, first attribute information, and second attribute information and computes a cluster appearing to have events with similar characteristics to each other,
computes a degree of similarity of characteristics of the events in the cluster as an evaluation value of the cluster,
compares the evaluation value of the cluster to the threshold associated with the filter information and determines whether or not the cluster is regarded to have events with similar characteristics,
references, upon detecting a packet having the specific event, the information related to the cluster regarded to have the events with similar characteristics and identifies in which cluster the packet is included, and
applies the countermeasure to a packet corresponding to the cluster identified to include the packet having the specific event.

3. The attack node set determination apparatus according to claim 2,
wherein the storage unit further stores a countermeasure to deal with an unauthorized access, and
wherein the computing unit further
references, upon detecting a packet related to the unauthorized access, information related to the cluster regarded to have the similar characteristics events, and identifies in which cluster the packet is included, and
applies the countermeasure to a packet corresponding to the cluster identified to include the packet having the specific event.

4. The attack node set determination apparatus according to claim 2,
wherein the computing unit obtains the first attribute information by transmitting a check packet capable of obtaining information on a node as a target, to the node.

5. The attack node set determination apparatus according to claim 2,
wherein the computing unit performs a clustering on a space having dimensions of respective items of the basic item information, the first attribute information, and the second attribute information in which a distance between two points is weighed in a prescribed manner for each item.

6. The attack node set determination apparatus according to claim 2,
wherein the evaluation value of the cluster is computed from any one or a combination thereof from among a ratio of events included in the computed cluster, the number of events, a variance value included in the cluster, and an average of a distance between a centroid of the cluster and an event included in the cluster.

7. The attack node set determination apparatus according to claim 2,
wherein the countermeasure is any one of a warning notice, bandwidth control, and packet filter.

8. An attack node set determination apparatus capable of outputting an event log created upon a passage or a reach of a packet and communicably coupled to an information processing device for conducting a countermeasure against an unauthorized access, comprising:
a computing unit; and
a storage unit,
wherein the storage unit stores therein filter information for extracting a specific event from among obtained event logs, a threshold associated with the filter information, and a countermeasure against a packet having the extracted specific event, and
wherein the computing unit extracts an event to be subject to a clustering by filtering event logs obtained during a prescribed period of time, extracts basic item information written in the extracted event, obtains information on a node related to an IP address included in the basic item information, as first attribute information, breaks down the IP address into octets, and computes the broken down IP address as second attribute information,
performs a clustering on a space having dimensions of part or all of the items in the basic item information, first attribute information, and second attribute information and computes a cluster appearing to have events with similar characteristics to each other,
computes a degree of similarity of characteristics of the events in the cluster as an evaluation value of the cluster,
compares the evaluation value of the cluster to a threshold corresponding to the filter information and determines whether or not the cluster is regarded to have events with similar characteristics, and
transmits information related to the cluster regarded to have the events with similar characteristics and a countermeasure to deal with the unauthorized access corresponding to the cluster, to the information processing device.

9. The attack node set determination apparatus according to claim 8,
wherein the information related to the cluster transmitted to the information processing device and regarded to have the similar characteristics includes the filter information, the basic item information used in performing the clustering, the first attribute information, and the second information.

10. An information processing device communicably coupled to the attack node set determination apparatus according to claim 8, comprising:
a computing unit; and
a storage unit,
wherein the storage unit of the information processing device stores therein the basic item information, the first attribute information, and the second attribute information, each of which is included in the received cluster regarded to have the similar characteristics events, as well as a countermeasure against a packet corresponding to the cluster, and
wherein the computing unit of the information processing device,
transmits, upon detecting a packet related to an unauthorized access, a check packet to each of an unauthorized access source and a node as an unauthorized access destination, obtains the first attribute information of the node, compares basic item information, first attribute information, and second attribute information of the packet, to the basic item information, the first attribute information, and the second attribute information stored in the storage unit of the information processing device, respectively, and determines in which cluster the node is included, and,
if the cluster is identified, applies the countermeasure to a packet corresponding to the cluster.

11. An information processing device communicably coupled to the attack node set determination apparatus according to claim 8, comprising:
a computing unit; and
a storage unit,
wherein the storage unit of the information processing device stores therein the basic item information, the first attribute information, and the second attribute information, each of which is included in the received cluster regarded to have the similar characteristics events, as well as a countermeasure against a packet corresponding to the cluster, and
wherein the computing unit of the information processing device,
transmits, upon detecting a packet related to an unauthorized access, a check packet to each of an unauthorized access source and a node as an unauthorized access destination, obtains the first attribute information of the node, compares basic item information, first attribute information, and second attribute information of the packet, to the basic item information, the first attribute information, and the second attribute information stored in the storage unit of the information processing device, respectively, and determines in which cluster the node is included, and,
if the cluster is identified, applies the countermeasure to a packet corresponding to an IP address included in the cluster.

12. An attack node set determination method used in an attack node set determination apparatus for creating an event log created upon a passage or a reach of a packet and conducts a countermeasure against an unauthorized access, the attack node set determination apparatus comprising:
a computing unit; and
a storage unit,
wherein the storage unit stores therein filter information for extracting a specific event from among obtained event logs, a threshold associated with the filter information, and a countermeasure against a packet having the extracted specific event, and
wherein the computing unit
extracts an event to be subject to a clustering by filtering the event logs obtained during a prescribed period of time or obtained until the number thereof reaches a prescribed number, using the filter information, extracts basic item information written in the extracted event, obtains information on a node related to an IP address included in the basic item information, as first attribute information, breaks down the IP address in a prescribed manner and computes the broken down IP address as second attribute information,
performs a clustering on a space having dimensions of part or all of the items in the basic item information, first attribute information, and second attribute information and
computes a cluster appearing to have events with similar characteristics to each other, computes a degree of similarity of characteristics of the events in the cluster as an evaluation value of the cluster,
compares the evaluation value of the cluster to the threshold associated with the filter information and determines whether or not the cluster is regarded to have events with similar characteristics,
references, upon detecting a packet having the specific event, the information related to the cluster regarded to have the events with similar characteristics and identifies in which cluster the packet is included, and
applies the countermeasure to a packet corresponding to the cluster identified to include the packet having the specific event.

13. The attack node set determination method according to claim 12,
wherein the evaluation value of the cluster is computed from any one or a combination thereof from among a ratio of events included in the computed cluster, the number of events, a variance value included in the cluster, and an average of a distance between a centroid of the cluster and an event included in the cluster.

14. The attack node set determination method according to claim 12,
wherein the countermeasure is any one of a warning notice, bandwidth control, and packet filter.

15. An attack node set determination method used in an attack node set determination capable of outputting an event log created upon a passage or a reach of a packet and communicably coupled to an information processing device for conducting a countermeasure against an unauthorized access, the attack node set determination apparatus comprising:
a computing unit; and
a storage unit,
wherein the storage unit stores therein filter information for extracting a specific event from among obtained event logs, a threshold associated with the filter information, and a countermeasure against a packet having the extracted specific event, and
wherein the computing unit extracts an event as a target to be subject to a clustering by filtering event logs obtained during a prescribed period of time using the filter information, extracts basic item information written in the extracted event, obtains information on a node related to an IP address included in the basic item information, as first attribute information, breaks down the IP address into octets, and computes the broken down IP address as second attribute information,
performs a clustering on a space having dimensions of part or all of the items in the basic item information, first attribute information, and second attribute information and computes a cluster appearing to have events with similar characteristics to each other,
computes a degree of similarity of characteristics of the events in the cluster as an evaluation value of the cluster,
compares the evaluation value of the cluster to a threshold corresponding to the filter information and determines whether or not the cluster is regarded to have events with similar characteristics, and
transmits information related to the cluster regarded to have the events with similar characteristics and a countermeasure to deal with the unauthorized access corresponding to the cluster, to the information processing device.

16. The attack node set determination method according to claim 15,
wherein the information related to the cluster transmitted to the information processing device and regarded to have the similar characteristics includes the filter information, the basic item information used in performing the clustering, the first attribute information, and the second information.

17. An attack dealing method used in an information processing device communicably coupled to the attack node set determination apparatus according to claim 15, the information processing device comprising:
a computing unit; and
a storage unit,
wherein the storage unit of the information processing device stores therein the basic item information, the first attribute information, and the second attribute information, each of which is included in the received cluster regarded to have the similar characteristics events, as well as a countermeasure against a packet corresponding to the cluster, and
wherein the computing unit of the information processing device,
transmits, upon detecting a packet related to an unauthorized access, a check packet to each of an unauthorized access source and a node as an unauthorized access destination, obtains the first attribute information of the node, compares basic item information, first attribute information, and second attribute information of the packet, to the basic item information, the first attribute information, and the second attribute information stored in the storage unit of the information processing device, respectively, and determines in which cluster the node is included, and,
if the cluster is identified, applies the countermeasure to a packet corresponding to the cluster.

18. An attack dealing method used in an information processing device communicably coupled to the attack node set determination apparatus according to claim 15, the information processing device comprising:
a computing unit; and
a storage unit,
wherein the storage unit of the information processing device stores therein the basic item information, the first attribute information, and the second attribute information, each of which is included in the received cluster regarded to have the similar characteristics events, as well as a countermeasure against a packet corresponding to the cluster, and
wherein the computing unit of the information processing device,
transmits, upon detecting a packet related to an unauthorized access, a check packet to each of an unauthorized access source and a node as an unauthorized access destination, obtains the first attribute information of the node, compares basic item information, first attribute information, and second attribute information of the packet, to the basic item information, the first attribute information, and the second attribute information stored in the storage unit of the information processing device, respectively, and determines in which cluster the packet is included, and,
if the cluster is identified, applies the countermeasure to a packet corresponding to an IP address included in the cluster.
